(19) United States
(12) Patent Application Publication
(10) Pub. No.: US 2013/0238617 A1
(43) Pub. Date: Sep. 12, 2013

(54) METHOD AND SYSTEM FOR IMPLEMENTING A SOCIAL NETWORK PROFILE

(71) Applicant: Richard Postrel, Miami Beach, FL (US)

(72) Inventor: Richard Postrel, Miami Beach, FL (US)

(21) Appl. No.: 13/565,827

(22) Filed: Aug. 3, 2012

Related U.S. Application Data
(63) Continuation-in-part of application No. 13/413,416, filed on Mar. 6, 2012.

(51) Int. Cl. G06F 17/30

(52) U.S. Cl. CPC G06F 17/30283
USPC 707/736

(57) ABSTRACT

A method of and system for operating a social networking service. The system includes a social network server computer that provides a social networking service, wherein a multiplicity of members register with the social networking service to selectively form social networks. The social network server computer generates a member profile for each of the members of the social networking service. A plurality of social networks may be formed by the social network server computer, each of the social networks including a subset of the multiplicity of members selectively linked to each other via the social network server computer. The social network server computer then generates a network profile for each social network that is based on an analysis of the member profiles of the members of the social network.

### CROSS-REFERENCE TO RELATED APPLICATIONS

This application is a continuation-in-part-application of Ser. No. 13/413,416 filed Mar. 6, 2012.

### TECHNICAL FIELD

This invention relates to social networks, and in particular to a method and system for implementing a network profile based on an analysis of the individual members of a social network.

### BACKGROUND OF THE INVENTION

Social networking is a paradigm in which groups of members are defined wherein the members interact with each other in desired ways. Typically members of a social network communicate electronically via a social networking service such as FACEBOOK or TWITTER. Members may share images and videos, and may have interactive chat sessions with messaging to select members of their social network.

Since members of social networks often have similar interests and socioeconomic status, it is desired to be able to utilize the vast amounts of information available from those members in order to market various products and services. Social networking services that are currently implemented often gather information from their members in a surreptitious manner whereby the members do not even know that their information is being used, or that their activities are being tracked, etc. It is therefore desired to be able to obtain information about the members on a voluntary basis. More notably, it is desired to be able to classify and quantify a social network and generate a network profile that is based on an aggregate analysis of the individual member profiles of each member of a given social network. A network profile may have many commercial applications, including but not limited to providing incentives and rewards to the members of the social network, commercializing the data of the social network and sharing the revenue that is generated with the members of the social network, and recommending a gift for a member of the social network.

### SUMMARY OF THE INVENTION

Provided is a method of and system for operating a social networking service. The system includes a social network server computer that provides a social networking service, wherein a multiplicity of members register with the social networking service to selectively form social networks. The social network server computer generates a member profile for each of the members of the social networking service. A plurality of social networks may be formed by the social network server computer, each of the social networks including a subset of the multiplicity of members selectively linked to each other via the social network server computer. The social network server computer then generates a network profile for each social network that is based on an analysis of the member profiles of the members of the social network.

Each of the member profiles may include data provided by the member such as age data, income data, education data, gender data, marriage status data, or member interests data. Each of the member profiles may also include data associated with activities performed by the member such as web browsing data, purchase transaction data, or messaging data. In addition, each of the member profiles may include data associated with the member and received from a third party service such as credit bureau data or psychographic data.

The network profile may be based on an average of the data in the member profiles, an aggregate of the data in the member profiles, a comparison of the data in the member profiles of the social network, or a combination of these or other types of data analysis.

The social network server computer may also be programmed to generate a network profile graphical display illustrating data compiled from the network profile, and provide the network profile graphical display to an external computer for display thereat.

### BRIEF DESCRIPTION OF THE DRAWING

FIG. 1a is a block diagram of the main aspect of generating a network profile for a social network.

FIG. 1b is a flowchart of the operation of the system of FIG. 1.

FIG. 1 is a block diagram of a first preferred embodiment of a first commercial application of the invention.

FIG. 2 is a block diagram of a second preferred embodiment of the first commercial application of the invention.

FIG. 3 is a flowchart of the operation of the first and second preferred embodiments of the first commercial application of the invention.

FIGS. 4 and 5 illustrate a graphical display of aggregated data from the network profile.

FIG. 6 illustrates the data flow for generation of a member profile and a network profile.

### DESCRIPTION OF THE PREFERRED EMBODIMENTS

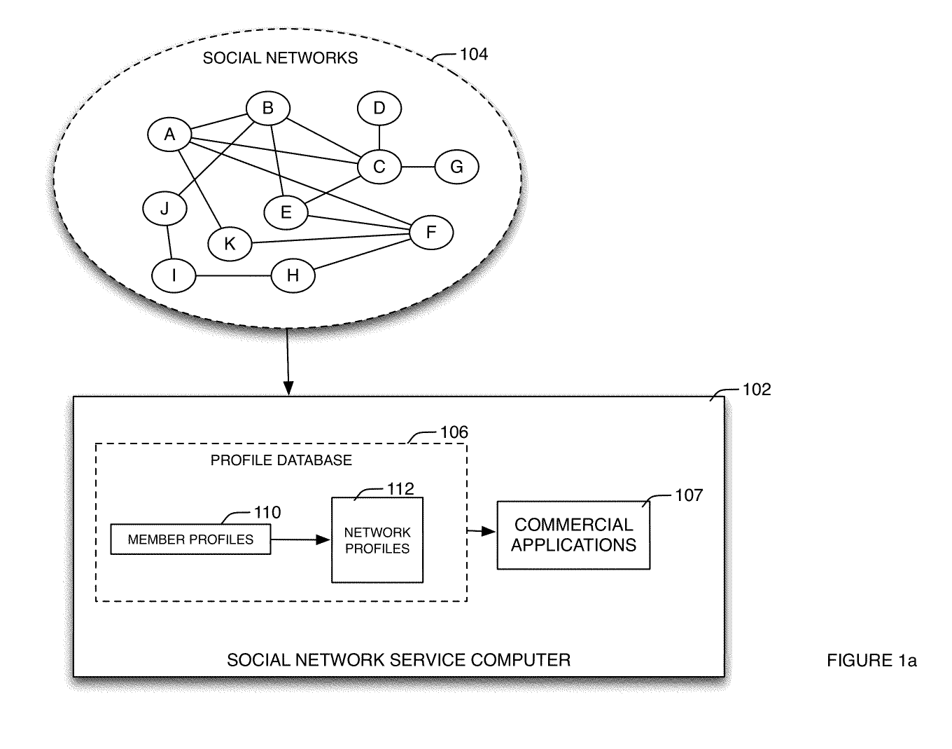

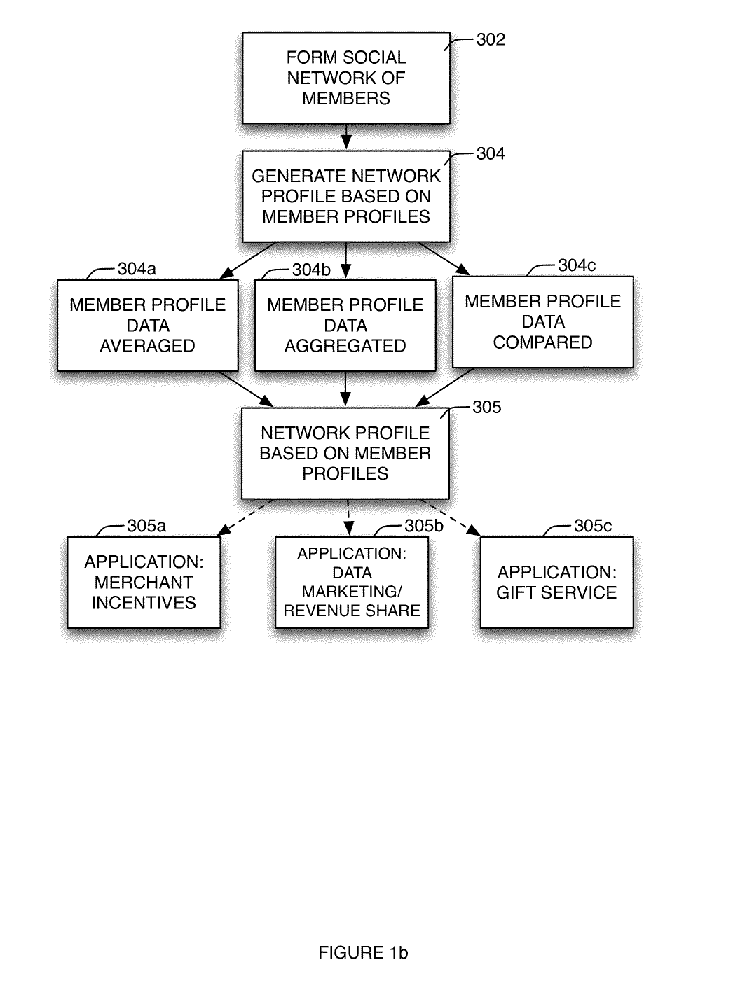

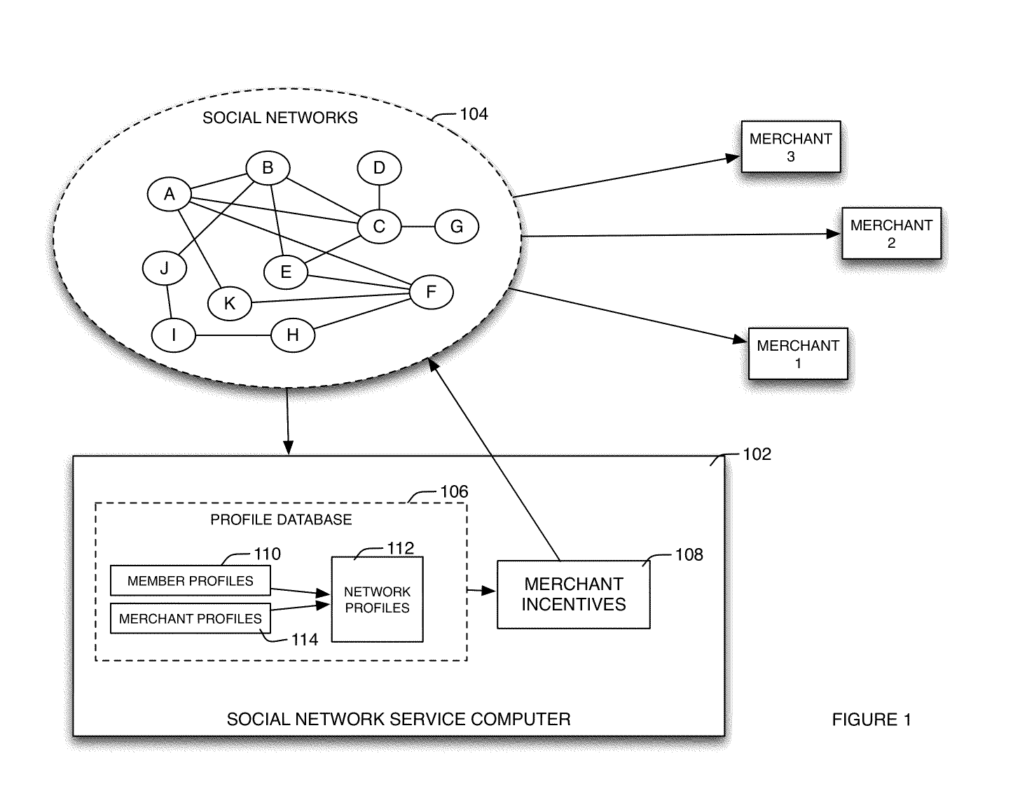

The preferred embodiments of the present invention and its commercial applications will now be described with respect to the drawing figures. FIG. 1a is a block diagram of the main aspect of generating a network profile for a social network, and FIG. 1b is a flowchart of the operation of the system of FIG. 1a. Interrelated social networks 104 are shown with various members A, B, C, D, E, F, G, H, I, J and K. Only eleven members are shown for illustrative purposes, although it is contemplated that the number of members that may be part of the social networks 104 is essentially unlimited. For example, the FACEBOOK social networking service claims to have over 500 million members worldwide. Social networks are constructs as well known the art that provide a communication paradigm amongst its various members. Social networks are groups of persons that interact with each other in some format(s), typically over an electronic communications network such as the Internet. Various social networking services exist, which facilitate interactions amongst the various constituent members that form the social networks. Examples of well-known existing social networking services include FACEBOOK, TWITTER, MYSPACE, AND GOOGLE+. These social networking services are made up of a multiplicity (i.e. very large number) of members that register with the social networking service in order to selectively form social networks.

These networks are selectively formed since each member of the social networking service determines or selects which social networks within the service he or she wishes to join. Thus, the social networking service enables its members to define various social networks in which the members choose to link with (or friend) each other to share information, images, videos, emails, chat, etc. In this embodiment, the members A, B, C, D, E, F, G, H, I, J and K shown within the dotted oval of FIG. 1 are all registered with the same social network server computer 102 (such as for example the

FACEBOOK social networking service) but form different social networks as follows:

social network A: A-B-C-F-K

social network B: B-A-J-E-C

social network C: C-A-B-D-G-E

social network D: D-C

social network E: E-B-C-F

social network F: F-A-E-K-H

social network G: G-C

social network H: H-F-I

social network I: I-J-H

social network J: J-B-I

social network K: K-A-F

That is, member A has linked to members B, C, F and K to form the social network A. Similarly, member B has linked to members A, J, E and C to form the social network B, and so forth. Any information that A chooses to share in his social network A will be received by B, C, F and K. Similarly, any information that B chooses to share in his social network B will be received by A, J, E and C, and so forth. Member A is considered to be the primary member of social network A since he is the common link. Similarly, member B is considered to be the primary member of the social network B since he is the common link. Any member of a social network who is not the primary member of that social network is considered to be a secondary member of that network. Each member of the social networking service will be a primary member to one social network (defined by the secondary members to whom he has linked), and each member is a secondary member to the social networks of those in his social network. Thus, member A is a secondary member to social networks B, C, F and K. Even though E is linked to B, E will not receive information received by B from A since E is not linked to A directly. The term social network 104 is used herein to refer to any of the social networks as described above.

At step 302 in the flowchart of FIG. 1b, the social network 104 may be formed amongst its various members utilizing the social network server computer 102 which runs the social networking service. The members of the social network 104 communicate with the social network server computer 102 by using various member computers (not shown), which may be desktop computers, laptop computers, tablets, smartphones, etc. These member computers communicate with the social network server computer 102 through a wired and/or wireless communications network(s) such as the Internet. Typically, each member will register or enroll with the social network server computer 102 and indicate their desire to join a particular social network 104 by linking with at least one of the constituent members of that social network. Any member may invite any other member to join his network, typically by an email message as known in the art. For example, member A has requested members B, C, F and K to link to him, which they have all accepted. Non-members may join the network if desired based on parameters established by the social networking service. As the various members register with the social network server computer 102 and then link with each other, they will be able to interact with each other in various ways, including but not limited to the interactions that will be described herein. Formation of social networks utilizing social network server computers and services is well known in the art.

In addition, members may invite other members of the social networking service, as well as non-members of the service, by issuing a broadcast invitation to groups of member and/or non-members as desired. This may occur over any type of medium, including but not limited to television or radio broadcasts, mass mail and email, etc. Invitees may accept the invitation to join the member's social network and register with the network.

Each member will provide to the social network server computer 102 data that is used to generate a member profile 110 that will be stored in the profile database 106 as shown in FIG. 1. The member profile 110 is usually generated by the social network server computer 102 as part of the registration process, but this may be done subsequent or prior to that process, and it may be amended as desired. The member profile 110 will include various pieces of information that are associated with the member, including but not limited to personal information of the member such as income, age, education level, gender, location, occupation, shopping habits, and/or prior transaction history. Prior transaction history could include purchase transactions and the like. Additionally, the member profile 110 may include a listing of the reward/loyalty/incentive programs with which the member is registered.

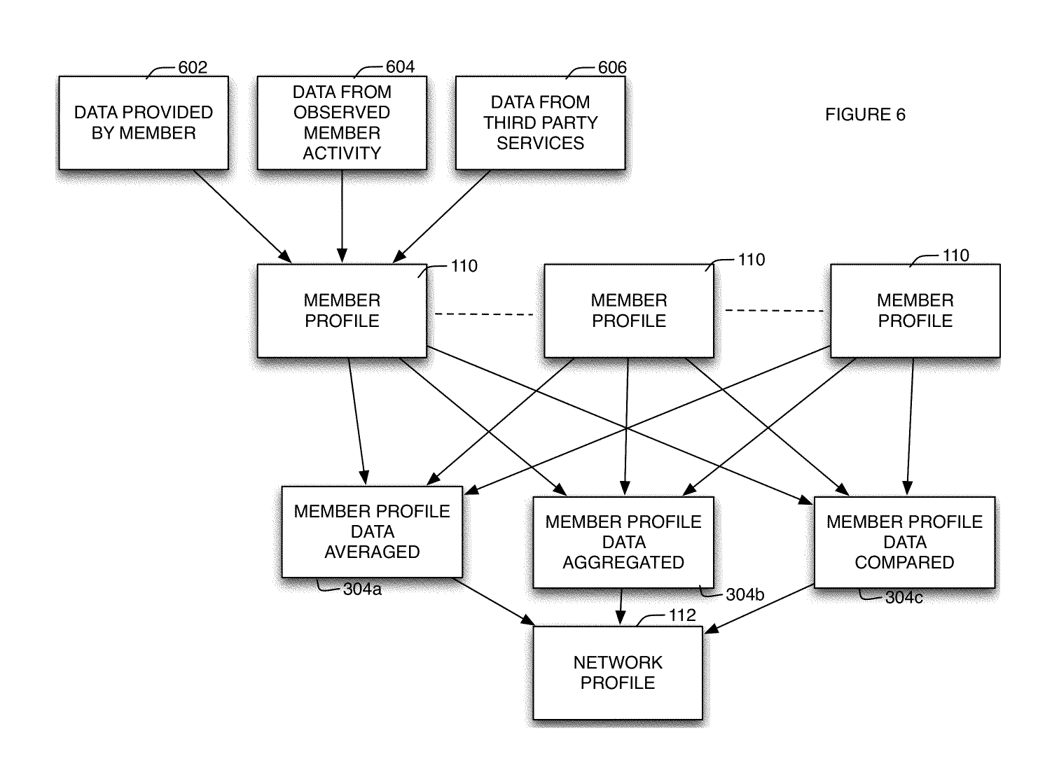

Further details of the generation of the member profile 110 for each member of the social networking service are now provided, with reference to FIG. 6. One component of the member profile 110 will include data that is provided by the member (block 602), usually during the registration process. This may include, but is not limited to, age data, income data, education data, gender data, marriage status data, or member interests data. For example, the member may fill in a registration form to indicate that the member is a 27 year old single male having an income between $100K-$250K, with a bachelor of science degree. The member may also enter certain personal interests in the profile form such as an interest in baseball, books and music.

Another component of the member profile 110 will include data that is observed or collected from an activity of the member (block 604). This may include web browsing data, purchase transaction data, or messaging data. In this case, the member may need to provide permission to the social networking service to monitor and collect his activity data in accordance with privacy laws. Assuming permission has been granted, the social networking service may then monitor his web browsing habits to determine for example that the member likes to read foreign newspapers or journals, or likes to shop on Amazon, etc. Similarly, when the member makes purchases online, the social networking service may be able to monitor those purchases and record which online stores he has used, and which products or services he has purchased or at least shown an interest in.

Another component of the member profile 110 will include data that is obtained from third party services such as credit bureaus and the like (block 606). Again, the member may need to provide permission to the social networking service to collect this type of data. Third party services exist that provide collect and provide data such as credit data and psychographic information.

As shown in FIG. 6, all of these data types 602, 604 and 606 may be collected by the social networking service at various times, and updated as desired, in order to generate the member profile 110. This is done for each member of the social networking service to enable the social networking service to generate various network profiles as will now be described.

At step 304 of FIG. 1b, the social network server 102 computer generates a network profile 112 for each of the various social networks within a social networking service. Thus, the social network server computer 102 will generate network profile A for social network A, which will be based on the member profiles for members A, B, C, F and K. Similarly, the social network server computer 102 will generate network profile B for social network B, which will be based on the member profiles for members B, A, J, E, and C, and so forth. The term network profile 112 is used herein to refer to any of the network profiles as described above. As such, each member will have an associated network profile 112 that is based on the members in his own social network.

Each network profile 112 is based on an analysis of the member profiles 110 of the constituent members that form a given social network and is stored in the profile database 106. The network profile is intended to be reflective of the information found in each of the constituent member profiles 110, and will subsequently be used in one or more various commercial applications, such as generating merchant incentives 108 (as shown in FIG. 1), commercialization of the data in the social network profile and revenue sharing amongst its constituent members, and/or providing a recommendation for a gift for a member of the social network.

The network profile 112 may be generated in one or more of various manners. As shown by step 304a in FIG. 1b and FIG. 6, some or all of the member profile data may be averaged so that the network profile 112 reflects (in whole or in part) an average profile of all of the constituent member profiles. Averages may easily be generated for numerical data types; for example, the network profile may contain the average member age, the average income level, average household size, average number of years married, average height, average weight, average family size, etc. Data types that are not numerical may be analyzed to provide a quasi-average indication as well. For example, if most members live in the northeast region of the United States but a few live in the south region, then the network profile for those members may simply indicate that the average member lives in the northeast region.

Additionally (or in the alternative), as shown by step 304b, some or all of the member profile data may be aggregated so that the network profile 112 reflects (in whole or in part) an aggregate profile of all of the constituent member profiles. For example, the network profile may indicate that 55% of the members are male and 45% are female, or it may indicate that 65% are adults and 35% are teenagers, or it may indicate that 4,657 of the 5,550 members graduated from college and the rest did not, or it may indicate that approximately half the members live inside the United States and half live outside the United States, etc.

Additionally (or in the alternative), as shown by step 304c, some or all of the member profile data may be compared so that the network profile 112 reflects (in whole or in part) a comparison of the member profiles within or outside of that social network. For example, the network profile A for social network A may indicate that 80% of its constituent members A, B, C, F and K work in the professional services industry compared to only 16% of the non-members of social network A (i.e. D, E, G, H, I, J, and/or non-members of the social networking service).

Other mechanisms for generating a network profile that is in some way representative of some or all of the constituent member profiles of that particular social network are also contemplated by this invention. As stated above, since each member of the social networking service will (likely) have a different social network from each other member based on to whom they connect in order to form their own social network within the social networking service, each member of the social networking service will thereby (likely) have a different network profile 112 based on the analysis of the member profiles of those constituent members that he connects to in his particular social network.

After the network profile 112 has been generated at step 304 and stored at step 305, it may be utilized in one or more various commercial applications. In my co-pending parent application Ser. No. 13/413,416 filed Mar. 6, 2012, entitled METHOD AND SYSTEM FOR PROVIDING INCENTIVES TO MEMBERS OF A SOCIAL NETWORK, I describe a methodology (referred to at step 305a) for utilizing the social network profile for providing an incentive such as reward points to members of a social network so that the individual members of the network may benefit from the value of their social network to a merchant or other entity. Also as described in the '416 application, and as shown at step 305b, the network profile information may be utilized as a source of marketing revenue, wherein the members of the participating social networks may share in the revenue streams generated by the network profile usage. Another type of commercialization of the network profile is a gift recommendation service for members of the social network as shown at step 305c, wherein recommendations for a gift of one of the network members may be made based on an analysis of the social network profile rather than just an analysis of the member profile as in the prior art.

### Application 1: Merchant Incentives

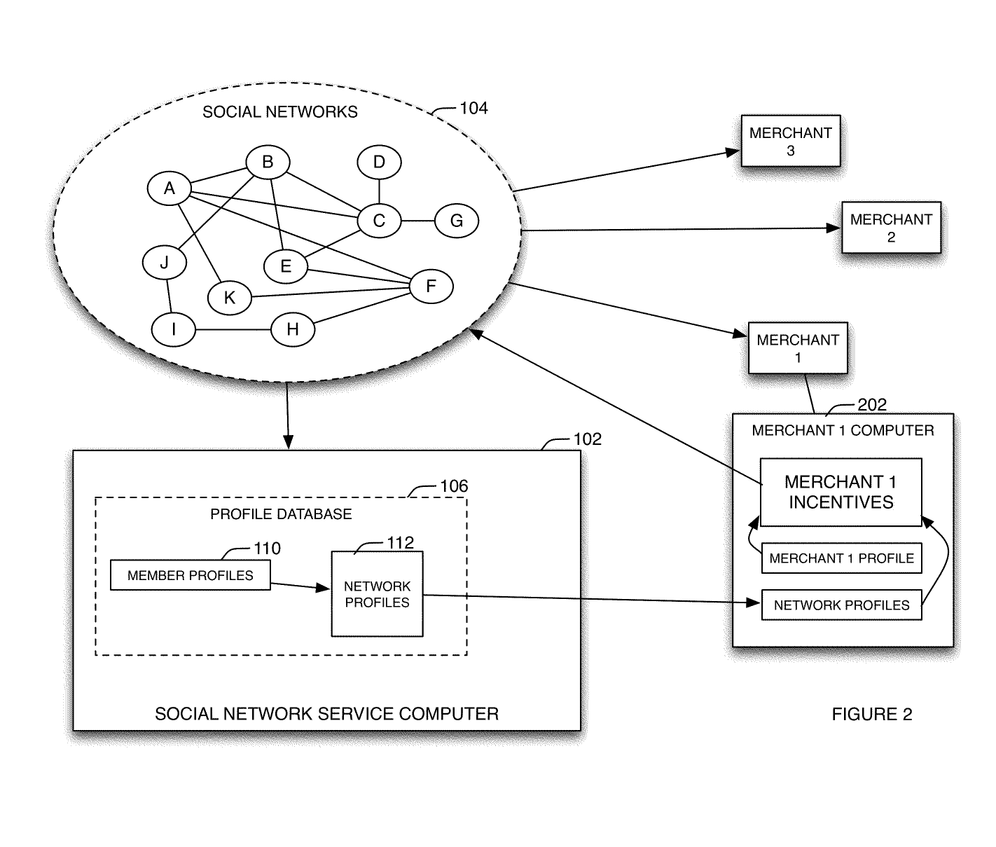

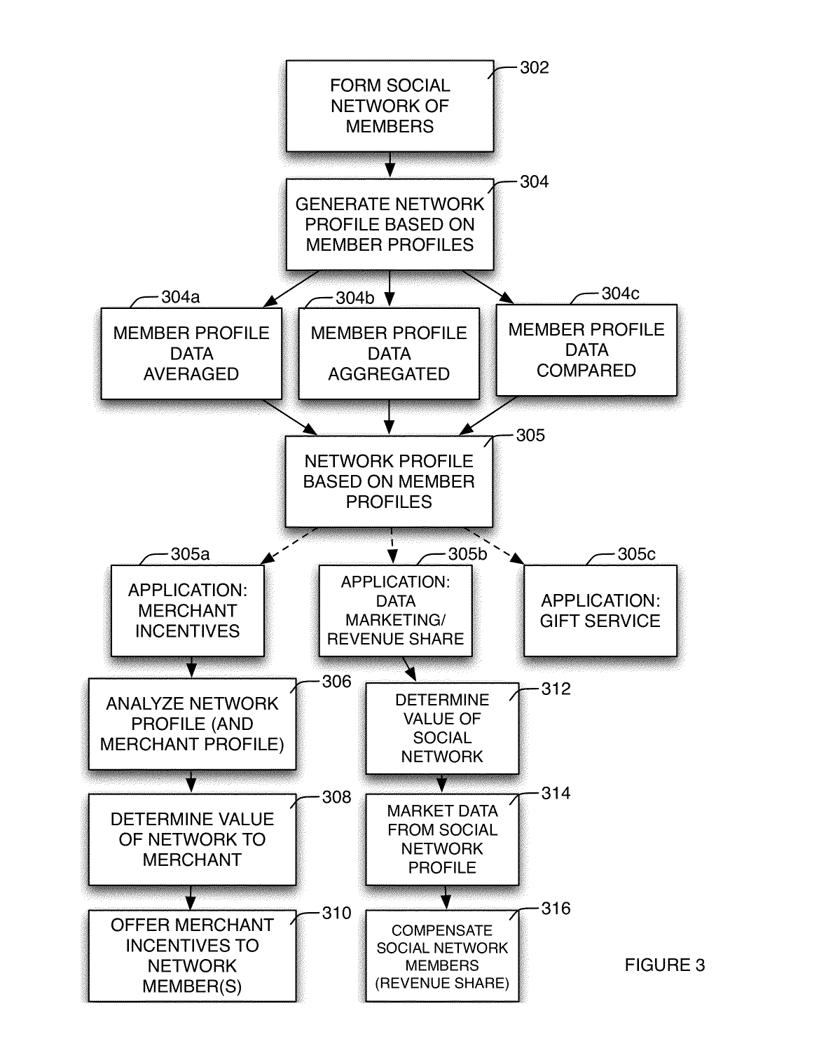

The merchant incentives application of step 305a is now explained as follows. FIGS. 1, 2 and 3 are similar to FIGS. 1a and 1b but add functionality for this particular commercial application. Note that like reference numerals are used for the same components of FIGS. 1a and 1b. As explained in the '416 application, the network profile 112 is analyzed at step 306 of FIG. 3 in order to be able to determine the value, to a merchant who participates in the program, of the constituent members of the social network in the aggregate. In this first embodiment as shown in FIG. 1, this network profile analysis is performed by the social network server computer 102. In a second embodiment described below, the analysis is performed by an individual merchant computer 202 as shown in FIG. 2.

The network profile 112 is analyzed (by either the social network server computer 102 or the merchant computer(s) 202, as may be applicable) in order to determine the constituent members' value to the merchant(s) and generate merchant incentives for distribution to the members of the social network. That is, by analyzing the properties of a network profile (and thus the properties of the members of that associated social network), incentives may be generated that will drive traffic to the participating merchants in a meaningful way. Rather than attempting to target each individual network member as in prior art marketing and incentive campaigns, this invention allows marketing to the social network members in the aggregate. Since members of the social network 104 share common interests that are defined by the social network itself, this leads to an intelligent incentive generation hereto unattainable in the prior art. This also provides an incentive for the members of that social network to provide their data in their profiles and to allow usage of their data. For example, a network profile may indicate that members of the associated social network have an average age of 27 years old and are generally interested in photography. This intelligence may be used by the merchants to generate an appropriate merchant incentive such as a coupon for a discounted camera lens. If a given member of this social network has not previously indicated in his member profile an interest in photography but has interests related to photography such that he has joined this social network for other reasons (e.g. an interest in art), this member will receive the lens coupon by virtue of his membership in the social network. Without this methodology, this member would not have been targeted for this incentive since he has not shown an interest in photography, but his membership in the social network for other closely related reasons enables him to receive the incentive. That is, this member has value to the merchant that sells the lens because of his association with the social network 104. This is just an example as to how this information may be utilized.

At step 310, the merchant incentives that are generated as a function of the member profiles are distributed by the social network server computer 102 to the members of the social network 102. This may be done in various ways, including electronic downloads, email, text message, etc. The social network members may then use them at the various merchants as desired.

In the methodology described above, all constituent members of a social network (i.e. the primary member and all secondary members) would receive the merchant incentives that are generated by the social network server computer 102 for that social network. For example, merchant incentives that are generated for social network A (by using the network profile A) would be distributed to all members of social network A (i.e. A, B, C, F, and K). A corollary to this is that member A would receive merchant incentives that are generated using network profiles A, B, C, F and K, since he is a primary member of social network A and a secondary member of social networks B, C, F and K (since he is linked to those members).

In another embodiment, merchant incentives that are generated based on a given social network will only be distributed to the primary member of that social network. Thus, merchant incentives generated based on network profile A would be distributed only to primary member A, merchant incentives generated based on network profile B would be distributed only to primary member B, an so forth. In one example, the merchant incentive may increase in value as the number of secondary members of a given social network increases. This benefits the merchant since it can collect data from many more members. This provides an incentive for members to invite many other members to join his social network since it would result in incentives having an increased value.

Optionally, a merchant profile(s) 114 may be used by the social network server computer 102 in addition to the network profile 112 in order to generate the merchant incentives 108. The merchant profiles 114 are associated with the various participating merchants and contain information about the merchant that may be useful in generating the merchant incentives. The merchant profiles may 114 for example contain guidelines and instructions to be used by the social network server computer 102, such as an instruction to generate incentives when the network profile indicates a certain age demographic, or income level, etc. As such, the merchants have a level of control over the incentive generation process carried out by the social network server computer 102.

In an alternative embodiment as shown in FIG. 2, the merchant computer(s) 202 execute the task of incentive generation rather than the social network server computer 102. In this embodiment, the processing is distributed amongst the merchants so that each merchant controls on an individual basis the incentive generation. The social network server computer 102 will generate the network profiles and provide them to each participating merchant. Each merchant will then use the network profiles, along with a merchant profile internally stored on its merchant computer 202, in order to generate its own merchant incentives. These merchant incentives may then be distributed directly by the merchant computer 202 to the members of the social network (primary and secondary or primary only), or alternatively they may be provided to the social network server computer so it may distribute the incentives as in the first embodiment of FIG. 1.

### Application 2: Revenue Share

In a second embodiment of this invention as described in the '416 application an shown at step 305b, members of a social network may be compensated for use of their data based upon parameters of the social network as provided through the network profile. As the network profile is generated, that information (and/or the information from the constituent member profiles) may be provided to third party services such that revenue is generated and received by the social networking service as consideration for use of that information. This would be done after being given permission by the members for use of their information, whether individually (use by a third party of their own member profile) or in the aggregate (use by the third party of their information in the network profile). The member would then share in the compensation revenue received by the social networking service from the third party. In one case, revenue may be shared with only the primary member of the social network for use of the information from all of the members of his social network. In another case, revenue may be shared with the primary member of the social network and the secondary members of his social network for use of the information from all of the members of his social network.

Third parties that may obtain member information from the various social networks via the social network server computer include merchants, rewards issuers, payment processors, and the like. Each of these third parties may have different uses for the information, but all would desire this information and as a result are willing to provide compensation to the member(s) for use of that information.

Referring again to FIG. 3, an example of this process operates as follows. The value of the social network is determined as a function of the network profile at step 312. For example, the third party marketing firm that is planning on utilizing the information in the social network profile will review certain metrics of the profile, for example the number of members in the network profile, the average annual income, the average age, etc. It may be determined that a social network with a relatively higher average annual income has more value to a third party marketer than does a relatively lower average annual income. Or, it may determine that a social network including 10,000 members has more value than one that comprises only 100 members. In any event, once the value of the social network profile is determined, then the data from the social network profile is utilized in a manner known in the art, such as for targeted advertising, in step 314. As revenue is generated (e.g. as advertising revenue is realized), then members of the social network that comprise the network profile being commercialized will receive a share or portion of that revenue in accordance with an agreed to formula, such as a 10% share, at step 316.

### Network Profile Display

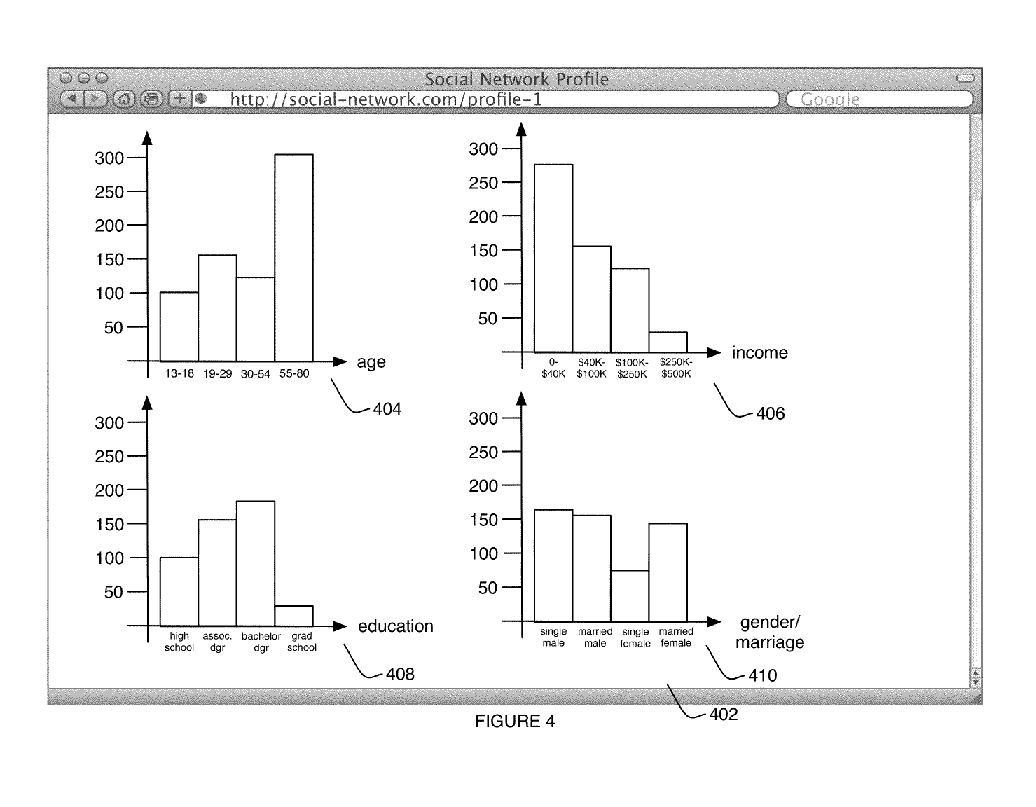

FIG. 4 illustrates a web page 402 with an exemplary graphical display of aggregated data from the network profile of member A of the social network, referred to here as John Smith. This web page 402 is typically generated and served by the social network service computer 102, although other services may provide the service if desired. As can be seen, web page 402 shows four different bar chart type graphs; age graph 404, income graph 406, education graph 408, and gender/marriage status graph 410. Of course, other ways of displaying the network profile data may be used as well known in the art. Similarly, other types of data may be displayed or otherwise made available to John Smith, another member of his social network, or other interested person or entity such as a third party marketing service, merchant, advertising agency and the like. Thus, as shown in FIG. 4, John Smith's social network has 100 members between the ages of 13-18, 150 members between the ages of 19-29, 125 members between the ages of 30 and 54, and 300 members between the ages of 55-80. This alerts the viewer that Smith has a large number of elderly friends and a relatively smaller number of teenage friends. Similar breakdowns are shown for income at graph 406, showing that Smith has a large number of friends in his social network with low incomes and only a few members having a larger income. Similar breakdowns are provided for education level at graph 408 (showing a low number of members with graduate degrees) and gender/marriage status at graph 410 (showing a low number of members who are single females).

This information may be viewed in greater detail by simply selecting a desired area of one of the graphs, and the composite data will be provided through an embedded hyperlink or the like. For example, if Smith were to select the age group 55-80 in age graph 404, he would be provided with a list of those friends (members of his social network) who have identified themselves in their profile as belonging to that age group.

This information may be used in various ways. In one case, the member Smith may use this to try to alter the makeup of his social network. For example, he may see that he has a large number of elderly friends and a low number of teenage friends, which may or may not be desirable to him. He could try to get more younger persons to join his social network in order to change the relative numbers if he so desires. Similarly, he could see that he knows few people with graduate degrees and perhaps try to get others to join his network who have a graduate degree.

In the case of member Smith negotiating a transaction with a marketing service (directly or through the social networking service) for use of his social network profile and perhaps access to the members of his network, this information is useful to the marketing service to ascertain the value of Smith's network. For example, a service that is interested in marketing to a younger group would not place as much value on this social network since the network profile indicates that Smith is friends with more older people than younger people. Similarly, the marketing service may find this network to have a relatively high value since most of the members have some type of college degree, etc. Depending on the needs of the marketing service with whom Smith is bidding for a transaction to provide access to the members of his network, the value of Smith's network will vary accordingly.

In addition to the profile data described above that is input by each member into their profile and is relatively static (i.e. does not change significantly over time), a network profile may take into account various activities performed by the constituent members of the network, without necessarily identifying the member that performed such activity. For example, the social networking service may collect web browsing data for each member and collate it into the social network profile(s) for that member. Similarly, content that is generated by a member may be analyzed and summarized into the network profile(s) for that member. This may include TWITTER posts, FACEBOOK posts, FLICKR photos, blog entries, GOGGLE searches, etc. As the social network server collects this information (which may be anonymous if desired), it can provide a statistical analysis to an interested party such as John Smith.

For example, an analysis over a certain period of time (e.g. one month) may indicate that the members of the Smith social network have a high interest in NFL football, since a large percentage of the content generated by the members of Smith's social network contains information related to NFL football (e.g. football related tweets on TWITTER). This may increase (or decrease, as the case may be) the value of Smith's social network, depending on the needs of the third party marketing service that is bidding for access to Smith's network. Again, Smith may understand that he has certain deficiencies in his social network as exemplified by the graphical displays, and then take action to change the network profile associated with his social network.

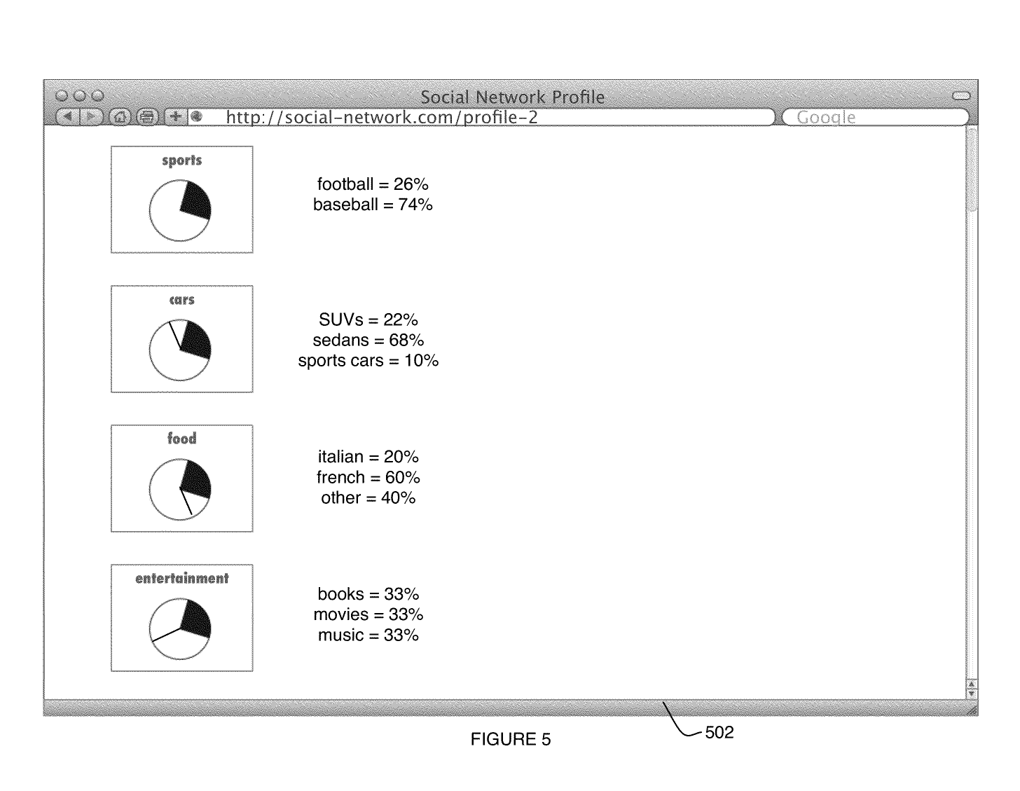

FIG. 5 illustrates a web page 502 that has been generated for Smith's social network, showing a summary of various categories that have been posted on the social network service such as FACEBOOK. By analyzing the posts submitted by the members of Smith's network, the social network service computer 102 is able to analyze the data and collate it into several categories of interest, shown here as sports, cars, food and entertainment. Thus, for a given time period, the members of Smith's social network posted content that mentioned football 26% of the time, and baseball 74% of the time. If a third party is interested in finding a social network whose members are interested in baseball, then Smith's network would likely have a high value based on this data. Similar analysis may be made for various topics and categories as may be desired. This information will likely change in a quick and dynamic fashion since many social network members will post content on a regular basis, which may effect the data analysis as displayed on FIG. 5.

What is claimed is:

1. A method of operating a social networking service comprising a social network server computer performing the steps of:
providing a social networking service, wherein a multiplicity of members register with the social networking service to selectively form social networks,
generating, for each of the members of the social networking service, a member profile;
forming a plurality of social networks, each of the social networks comprising a subset of the multiplicity of members selectively linked to each other via the social network server computer, and
generating, for each of the social networks, a network profile associated with the social network based on an analysis of the member profiles of the members of the social network.

2. The method of claim 1 wherein each of the member profiles comprises data provided by the member.

3. The method of claim 2 wherein the data provided by the member comprises at least one of age data, income data, education data, gender data, marriage status data, or member interests data.

4. The method of claim 1 wherein each of the member profiles comprises data associated with activities performed by the member.

5. The method of claim 4 wherein the data associated with activities performed by the member comprises at least one of web browsing data, purchase transaction data, or messaging data.

6. The method of claim 1 wherein each of the member profiles comprises data associated with the member and received from a third party service.

7. The method of claim 6 wherein the data associated with the member and received from a third party service comprises at least one of credit bureau data or psychographic data.

8. The method of claim 1 wherein the network profile comprises averaged data based on an average of data in the member profiles of the social network.

9. The method of claim 1 wherein the network profile comprises aggregated data based on an aggregate of data in the member profiles of the social network.

10. The method of claim 1 wherein the network profile comprises comparison data based on a comparison of data in the member profiles of the social network.

11. The method of claim 1 wherein the social network server computer performs the additional steps of:
generating a network profile graphical display, the network profile graphical display illustrating data compiled from the network profile, and
providing the network profile graphical display to an external computer for display thereat.

12. A social network server computer programmed to:
provide a social networking service, wherein a multiplicity of members register with the social networking service to selectively form social networks,
generate, for each of the members of the social networking service, a member profile;
form a plurality of social networks, each of the social networks comprising a subset of the multiplicity of the members linked to each other via the social network server computer, and
generate, for each of the social networks, a network profile associated with the social network based on an analysis of the member profiles of the members of the social network.

13. The social network server computer of claim 12 wherein each of the member profiles comprises data provided by the member.

14. The social network server computer of claim 13 wherein the data provided by the member comprises at least one of age data, income data, education data, gender data, marriage status data, or member interests data.

15. The social network server computer of claim 12 wherein each of the member profiles comprises data associated with activities performed by the member.

16. The social network server computer of claim 15 wherein the data associated with activities performed by the member comprises at least one of web browsing data, purchase transaction data, or messaging data.

17. The social network server computer of claim 12 wherein each of the member profiles comprises data associated with the member and received from a third party service.

18. The social network server computer of claim 17 wherein the data associated with the member and received from a third party service comprises at least one of credit bureau data or psychographic data.

19. The social network server computer of claim 12 wherein the network profile comprises averaged data based on an average of data in the member profiles of the social network.

20. The social network server computer of claim 12 wherein the network profile comprises aggregated data based on an aggregate of data in the member profiles of the social network.

21. The social network server computer of claim 12 wherein the network profile comprises comparison data based on a comparison of data in the member profiles of the social network.

22. The social network server computer of claim 12 further programmed to:
generate a network profile graphical display, the network profile graphical display illustrating data compiled from the network profile, and
provide the network profile graphical display to an external computer for display thereat.
